(19) United States
(12) Patent Application Publication
(10) Pub. No.: US 2019/0042017 A1
(43) Pub. Date: Feb. 7, 2019

(54) FINGER RECOGNITION TOUCH SCREEN

(71) Applicant: Primax Electronics Ltd., Taipei (TW)

(72) Inventor: Tsung-Yi Lu, Taipei (TW)

(21) Appl. No.: 15/830,817

(22) Filed: Dec. 4, 2017

Related U.S. Application Data
(60) Provisional application No. 62/542,120, filed on Aug. 7, 2017.

(30) Foreign Application Priority Data
Sep. 22, 2017 (TW) 106132658

(51) Int. Cl. G06F 3/044; G06K 9/00; G06F 3/041

(52) U.S. Cl. CPC G06F 3/044; G06K 9/001; G06F 2203/04112; G06F 3/0416; G06K 9/0002

(57) ABSTRACT

The present invention provides a fingerprint recognition touch screen, including a display panel, a metal mesh layer, and a transparent cover plate. The transparent cover plate is disposed above the metal mesh layer and the driver circuit. The metal mesh layer has a plurality of junctions, when a fingerprint surface presses the transparent cover plate, the junctions of the metal mesh layer have respective capacitance states in response to the fingerprint surface located above the junctions, and the capacitance states may be learned by means of a driver circuit to determine a shape of the fingerprint surface.

### FIELD OF THE INVENTION

The present invention relates to a touch screen, and in particular, to a touch screen capable of performing fingerprint recognition.

### BACKGROUND OF THE INVENTION

Touch screens are often applied to mobile devices such as notebook computers or mobile phones, and are used for providing a cursor controlling function. Recently, because online payment and computer security is taken into consideration, an increasing number of notebook computers and mobile phones provide a fingerprint read module, to facilitate reading fingerprint data of a user to perform security management and control. As shown in FIG. 1, in the conventional technology, a notebook computer 9 has a touch screen 91 and a fingerprint read module 92 that are disposed in a mutually separated manner. The touch screen 91 is only provided for a user to implement a cursor controlling function, and the fingerprint read module 92 is only provided for the user to implement a fingerprint sensing function.

However, separate disposition of touch screen 91 and a fingerprint read module 92 causes inconvenience in terms of either mechanism assembly or user experience. Therefore, conventional touch screens still need to be improved.

### SUMMARY OF THE INVENTION

A main objective of the present invention is to provide a fingerprint recognition touch screen, where a metal mesh layer is disposed between a transparent cover plate and a display panel, to detect a fingerprint and a path of finger movement.

A preferred implementation concept of the present invention is to provide a fingerprint recognition touch screen, including:

a display panel, having a display surface;

a metal mesh layer, disposed above the display surface, where the metal mesh layer has a first conductive mesh sheet and a second conductive mesh sheet, and the first conductive mesh sheet and the second conductive mesh sheet are vertically stacked and form a plurality of junctions, where each junction has a capacitance state;

a driver circuit, electrically connected to the metal mesh layer; and

a transparent cover plate, disposed above the metal mesh layer and the driver circuit, where

when a fingerprint surface presses the transparent cover plate, the junctions of the metal mesh layer individually correspondingly generate the capacitance states in response to a plurality of fingerprint ridge and a plurality of fingerprint valley of the fingerprint surface located above the junctions, and the driver circuit performs integration to determine a shape of the fingerprint surface according to the capacitance states.

In a preferred embodiment, the first conductive mesh sheet has a plurality of first wires, and the second conductive mesh sheet has a plurality of second wires, where the first wires of the first conductive mesh sheet receive a signal at a fixed frequency transmitted from the driver circuit, and the second wires of the second conductive mesh sheet generate signals at different frequencies in response to the capacitance states of the junctions.

In a preferred embodiment, the display panel is a thin film transistor (TFT) liquid crystal display panel or an active-matrix organic light emitting diode (AMOLED) display panel.

In a preferred embodiment, the transparent cover plate is a glass cover plate, where the metal mesh layer is formed on a lower surface of the glass cover plate in a surface pressing manner, and the driver circuit is attached to the lower surface of the glass cover plate in a chip-on-glass manner.

In a preferred embodiment, the glass cover plate has a non-conductive film, and the non-conductive film forms a color in a non conductive optical coating (NCOC) manner.

In a preferred embodiment, the metal mesh layer is superimposed above the display surface, where the metal mesh layer has a wire high-density area and a wire low-density area, and a partial area, corresponding to the wire high-density area, of the display surface may display a mark, to guide a user to press.

In a preferred embodiment, the fingerprint recognition touch screen further includes an optical clear adhesive (OCA), located between the metal mesh layer and the transparent cover plate, to bond the metal mesh layer and the transparent cover plate.

### BRIEF DESCRIPTION OF THE DRAWINGS

FIG. 1 is a schematic three-dimensional diagram of a conventional electronic device equipped with a fingerprint recognition module and a touch screen that are disposed in a mutually separated manner;

FIG. 2 is a schematic three-dimensional diagram of a notebook computer equipped with a fingerprint recognition touch screen of the present invention;

FIG. 3 is a sectional view of a first embodiment of a fingerprint recognition touch screen of the present invention;

FIG. 4 is a top view of a metal mesh layer in the first embodiment of the fingerprint recognition touch screen of the present invention;

FIG. 5 is a sectional view of a second embodiment of a fingerprint recognition touch screen of the present invention; and

FIG. 6 is a sectional view of a third embodiment of a fingerprint recognition touch screen of the present invention.

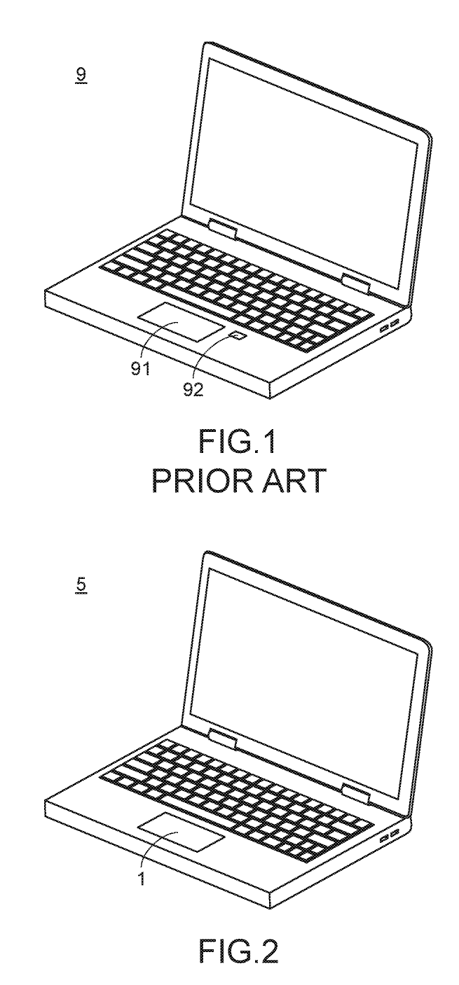

### DETAILED DESCRIPTION OF THE PREFERRED EMBODIMENT

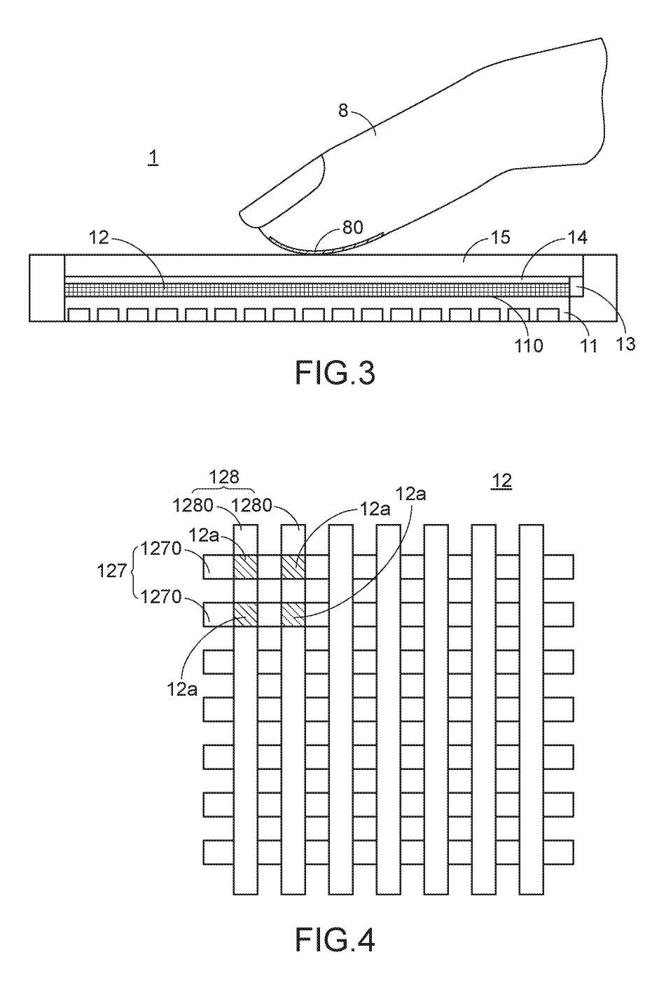

A fingerprint recognition touch screen of the present invention is applied to an electronic device such as a notebook computer or a smart phone. However, regardless of being applied to a notebook computer or a smart phone, the fingerprint recognition touch screen of the present invention has dual functions of controlling a cursor as a touch pad and entering an instruction as a sensing panel. First, referring to FIG. 2 and FIG. 3, FIG. 2 is a schematic three-dimensional diagram of a notebook computer equipped with a fingerprint recognition touch screen of the present invention, and FIG. 3 is a sectional view of a first embodiment of a fingerprint recognition touch screen of the present invention. A fingerprint recognition touch screen 1 of the present invention is applied to a notebook computer 5. As shown FIG. 3, the fingerprint recognition touch screen 1 of the first embodiment of the present invention includes a display panel 11, a metal mesh layer 12, a driver circuit 13, an optical clear adhesive (OCA) 14, and a transparent cover plate 15.

A sequence in which the foregoing components are sequentially stacked from bottom to top is the display panel 11, the metal mesh layer 12, the OCA 14, and the transparent cover plate 15. Moreover, the driver circuit 13 is preferably located on a same layer as the metal mesh layer 12, that is, the metal mesh layer 12 and the driver circuit 13 are disposed between the transparent cover plate 15 and the display panel 11, however, which is an example rather than a limitation. Further, the OCA 14 is located between the metal mesh layer 12 and the transparent cover plate 15, to bond metal mesh layer 12 and the transparent cover plate 15. The transparent cover plate 15 is exposed on the outermost layer for a user to press a finger onto it. In terms of overall proportion, preferably, the actual thickness of the transparent cover plate 15 is 0.5 cm, the actual thickness of the OCA 14 is 0.1 cm, and the actual thickness of the metal mesh layer 12 is 0.1 cm. However, no limitation is imposed on a size in the present invention.

Specifically, the display panel 11 has a display surface 110, the display surface 110 emits light upward for display, that is, emitting light toward a direction of the metal mesh layer 12 and the transparent cover plate 15. In the first embodiment of the present invention, the metal mesh layer 12 is completely superimposed on the entire display surface 110, that is, the area of the metal mesh layer 12 is the same as the area of the display surface 110, so that cursor control and fingerprint recognition functions can be implemented all over the display surface 110. Because the metal mesh layer 12 has transparency, an image on the display surface 110 can pass through metal mesh layer 12 and be displayed through the transparent cover plate 15. A TFT liquid crystal display panel or an AMOLED display panel may be selected as the display panel 11. However, no limitation is imposed herein.

Generally, the metal mesh layer 12 means a conductive metal mesh pattern formed by pressing a metal material, such as silver or copper, on a plastic film such as PET. Referring to FIG. 3 and FIG. 4 together, FIG. 4 is a top view of the metal mesh layer 12 in the first embodiment of the fingerprint recognition touch screen of the present invention. The metal mesh layer 12 has a first conductive mesh sheet 127 and a second conductive mesh sheet 128. The first conductive mesh sheet 127 and the second conductive mesh sheet 128 are vertically stacked, and forms a plurality of junctions 12a. Each of the junctions 12a has a capacitance state. The capacitance states of the junctions 12a may be affected and changed in response to a plurality of fingerprint ridges and a plurality of fingerprint valleys of a fingerprint surface 80 of a finger 8 pressing the transparent cover plate 15 above the junctions 12a and individually form respective capacitance states. The capacitance state herein may be a capacitance value.

A manner in which a capacitance state of a junction 12a of the metal mesh layer 12 of the present invention is determined is described below in detail. The first conductive mesh sheet 127 of the present invention has a plurality of first wires 1270, the second conductive mesh sheet 128 of the present invention has a plurality of second wires 1280, and the foregoing junctions 12a are formed at intersections between the first wires 1270 and the second wires 1280. It should be specifically noted that although a shape of the first wire 1270 and the second wire 1280 is drawn as an intersection of straight lines in the figure, no limitation is imposed on the shape in the present invention. As long as the first wire 1270 and the second wire 1280 can form a junction, the shape falls within the scope claimed in the present invention.

Further, the first wire 1270 and the second wire 1280 can be made to have a width of 5 microns, so that the resolution thereof can be used to distinguish fingerprint ridges and fingerprint valleys of the fingerprint surface 80. In the first embodiment, the first wires 1270 and the second wires 1280 are uniformly distributed, so that the entire metal mesh layer 12 has uniform wire density. Moreover, the driver circuit 13 is electrically connected to the first conductive mesh sheet 127 and the second conductive mesh sheet 128 of the metal mesh layer 12. To perform fingerprint recognition, the first wire 1270 is used as a transmitter, and the second wire 1280 is used as a receiver. The driver circuit 13 sends a signal at a fixed frequency to the first wires 1270 of the first conductive mesh sheet 127. Because the plurality of fingerprint ridges and the plurality of fingerprint valleys of the fingerprint surface 80 may affect the capacitance states of the junctions 12a, the capacitance states of the junctions 12a lead the second wires 1280 of the second conductive mesh sheet 128 to generate signals at different frequencies. Hence, frequency changes on the second wires 1280 can be learned by using the driver circuit 13, subsequently, positions of the fingerprint ridges and the fingerprint valleys can be calculated, and further, integration is performed to determine a shape of the fingerprint surface 80. In practical application, if the shape of the fingerprint surface conforms to a shape of a fingerprint surface pre-stored in a system, identity authentication is completed, and the notebook computer 5 allows the user to continue to perform an operation.

Besides, while features of the fingerprint ridges and the fingerprint valleys are obtained, position and movement data of a finger of the user is learned. Therefore, the position data may be used as operation information for operating the touch screen. Further, because the fingerprint recognition touch screen 1 of the present invention has the display panel 11, the fingerprint recognition touch screen 1 can be used as a second screen of the notebook computer 5 and can be used for displaying relevant information of the notebook computer 5 or provide information guidance for fingerprint unlocking.

Referring to FIG. 3 again, the transparent cover plate 15 of the present invention is a glass cover plate, where the metal mesh layer 12 is formed on a lower surface of the glass cover plate in a surface pressing manner, and the driver circuit 13 is attached to the lower surface of the glass cover plate in a chip-on-glass manner. In a preferred embodiment, the glass cover plate has a non-conductive film (not shown in the figure), and the non-conductive film is a layer of non-conductive film (not shown in the figure) formed by evaporating and depositing an optical material on the glass cover plate by using a non conductive optical coating (NCOC) process. Different film layers may reflect light of different colors, so that the glass cover plate has colors. Therefore, in terms of appearance, different colors may be formed according to requirements.

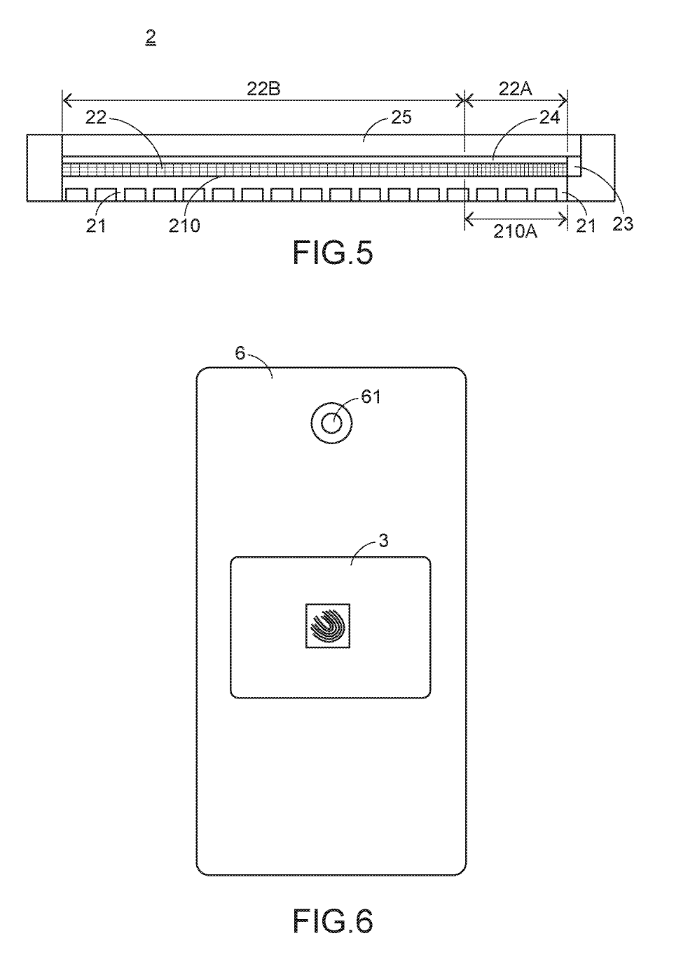

Referring to FIG. 5, FIG. 5 is a sectional view of a second embodiment of a fingerprint recognition touch screen of the present invention. A second embodiment of a fingerprint recognition touch screen 2 of the present invention is similar to the first embodiment, and includes a display panel 21, a metal mesh layer 22, a driver circuit 23, an OCA 24, and a transparent cover plate 25, whose specific functions are described in detail in the foregoing, and therefore, are not described herein again. The second embodiment differs from the first embodiment in that the metal mesh layer 22 of the second embodiment has a wire high-density area 22A and a wire low-density area 22B. The wire high-density area 22A can be used for recognizing a fingerprint and controlling a cursor, and the wire low-density area 22B can only be used for controlling a cursor. A partial area 210A, corresponding to the wire high-density area 22A, of the display surface 210 can emit light to display a mark (not shown in the figure), to guide a user to press at a position that should be pressed at (that is, a position, corresponding to the wire high-density area 22A, of the transparent cover plate 25) on the transparent cover plate 25. An advantage of performing fingerprint recognition in a specific area is that: high resolution at which a fingerprint can be recognized can be achieved by disposing a wire high-density area 22A in a specific area, and for parts other than the specific region, because a wire low-density area 22B is disposed to make wire density relatively low, the parts only need to meet a requirement for controlling the touch screen, to achieve good transparency. In addition, a load of the driver circuit can be further reduced, so as to make the driver circuit keep volume miniaturization as much as possible.

Referring to FIG. 6, FIG. 6 is a sectional view of a third embodiment of a fingerprint recognition touch screen of the present invention. In the third embodiment, a fingerprint recognition touch screen 3 of the present invention is applied to a smart phone 6. In the third embodiment of the present invention, because the fingerprint recognition touch screen 3 of the present invention also has a fingerprint sensing function, it is not needed to additionally dispose a fingerprint sensing module on the smart phone 6. The fingerprint recognition touch screen 3 is particularly suitable for a smart phone having a high screen-to-body ratio because since it is difficult for the smart phone 6 having a high screen-to-body ratio to make additional room for a fingerprint sensing module. In a preferred implementation aspect, the fingerprint recognition touch screen 3 of the present invention is disposed on the back surface of the smart phone 6 as a second display screen of the smart phone 6. In this application, the fingerprint recognition touch screen 3 can be used when a self-portrait is taken. That is, while a self-portrait is taken by using a rear-facing camera 61, framing can be confirmed by viewing the fingerprint recognition touch screen 3, so that deposition of a front-facing camera can be omitted. Besides, the fingerprint recognition touch screen 3 can also be used as a common touch screen for entering an instruction. In addition, the fingerprint recognition touch screen of the present invention can also used as a front screen of the smart phone 6, and no limitation is imposed herein.

In conclusion, the fingerprint recognition touch screen of the present invention helps recognize a fingerprint and a finger position by means of a metal mesh layer added above a display panel. In this way, a touch screen functional module and a fingerprint read functional module can be integrated on an electronic device, so as to form a multi-functional fingerprint recognition touch screen, which is easier and more direct to a user in terms of operation. In addition, in terms of mounting space, the fingerprint recognition touch screen can be arranged inside an electronic device more easily.

The foregoing embodiments merely illustratively describe the principles and effects of the present invention and explain technical features of the present invention instead of limiting the protection scope of the present invention. All the changes or equivalent arrangements that can be easily completed by persons skilled in the art without departing from the technical principles and spirit of the present invention fall within the scope claimed by the present invention. Therefore, the protection scopes of the present invention are listed as the following claims.

What is claimed is:

1. A fingerprint recognition touch screen, comprising:
a display panel, having a display surface;
a metal mesh layer, disposed above the display surface, wherein the metal mesh layer has a first conductive mesh sheet and a second conductive mesh sheet, and the first conductive mesh sheet and the second conductive mesh sheet are vertically stacked and form a plurality of junctions, wherein each junction has a capacitance state;
a driver circuit, electrically connected to the metal mesh layer; and
a transparent cover plate, disposed above the metal mesh layer and the driver circuit, wherein
when a fingerprint surface presses the transparent cover plate, the junctions of the metal mesh layer individually correspondingly generate the capacitance states in response to a plurality of fingerprint ridge and a plurality of fingerprint valley of the fingerprint surface located above the junctions, and the driver circuit performs integration to determine a shape of the fingerprint surface according to the capacitance states.

2. The fingerprint recognition touch screen according to claim 1, wherein the first conductive mesh sheet has a plurality of first wires, and the second conductive mesh sheet has a plurality of second wires, wherein the first wires of the first conductive mesh sheet receive a signal at a fixed frequency transmitted from the driver circuit, and the second wires of the second conductive mesh sheet generate signals at different frequencies in response to the capacitance states of the junctions.

3. The fingerprint recognition touch screen according to claim 1, wherein the display panel is a thin film transistor (TFT) liquid crystal display panel or an active-matrix organic light emitting diode (AMOLED) display panel.

4. The fingerprint recognition touch screen according to claim 1, wherein the transparent cover plate is a glass cover plate, wherein the metal mesh layer is formed on a lower surface of the glass cover plate in a surface pressing manner, and the driver circuit is attached to the lower surface of the glass cover plate in a chip-on-glass manner.

5. The fingerprint recognition touch screen according to claim 1, wherein the glass cover plate has a non-conductive film, and the non-conductive film forms a color in a non conductive optical coating (NCOC) manner.

6. The fingerprint recognition touch screen according to claim 1, wherein the metal mesh layer is superimposed above the display surface, wherein the metal mesh layer has a wire high-density area and a wire low-density area, and a partial area, corresponding to the wire high-density area, of the display surface may display a mark, to guide a user to press.

7. The fingerprint recognition touch screen according to claim 1, further comprising an optical clear adhesive (OCA), located between the metal mesh layer and the transparent cover plate, to bond the metal mesh layer and the transparent cover plate.
